(19) United States
(12) Patent Application Publication
(10) Pub. No.: US 2026/0232521 A1
(43) Pub. Date: Aug. 13, 2026

(54) INTELLIGENT MASSAGE SYSTEM AND INTELLIGENT MASSAGE CONTROL METHOD

(71) Applicant: Yu-Hao Lee, Taoyuan City (TW)

(72) Inventors: Yu-Hao Lee, Taoyuan City (TW); Sheng-Kuo Lee, Miaoli City (TW); Tsai-Hsuan Lee, Taoyuan City (TW); Jhe-Wei Wu, Taoyuan City (TW)

(21) Appl. No.: 19/533,903

(22) Filed: Feb. 9, 2026

(30) Foreign Application Priority Data
Feb. 10, 2025 (TW) 114104920

(51) Int. Cl. A61H 7/00; G06N 5/02

(52) U.S. Cl. CPC A61H 7/004; G06N 5/027; A61H 2201/0157; A61H 2201/0192; A61H 2201/1207; A61H 2201/1623; A61H 2201/165; A61H 2201/1659; A61H 2201/5061; A61H 2201/5069; A61H 2201/5071; A61H 2201/5092; A61H 2205/062

(57) ABSTRACT

An intelligent massage system and method for intelligent massage control are provided. The system includes multi-modal sensing array for capturing a subject's real-time dynamic data during massage sessions, dynamic data including pressure distribution, force vector, and three-dimensional trajectory of massage movements; plan construction module including processor and artificial intelligence (AI) engine, AI engine being configured to dynamically analyze the subject's health profile and satisfaction evaluation metric and generate personalized massage protocol defining control instructions for automated actuator for applying massage force to the subject; real-time adjustment module configured to monitor the subject's physiological state based on sensor signals from multi-modal sensing array during execution of personalized massage protocol and dynamically modify parameters of personalized massage protocol based on feedback control loop integrating monitored physiological state and pre-trained professional massage logic; and automated actuator coupled to real-time adjustment module and configured to physically implement modified personalized massage protocol on the subject.

### FIELD OF THE DISCLOSURE

The present disclosure relates to massage systems and massage control technologies, and more particularly to an intelligent massage system and an intelligent massage control method that dynamically generate, execute, and optimize personalized massage operations using artificial intelligence (AI), multi-modal sensing, and real-time feedback control.

### BACKGROUND OF THE DISCLOSURE

Conventional massage systems and massage devices generally rely on predefined massage programs, fixed force profiles, or manually selected massage techniques. Such systems typically lack the ability to dynamically adapt massage force, direction, timing, and workflow in response to individual user characteristics or real-time physiological feedback. For example, conventional robotic massage devices often follow pre-programmed, static paths that do not account for the unique physiological needs or real-time feedback of a user.

Existing technologies may include limited pressure sensing or motion tracking, but they do not provide an integrated framework that combines multi-modal sensing, artificial-intelligence-based analysis, and closed-loop mechanical control to continuously optimize massage execution. As a result, conventional massage systems are unable to achieve a high degree of personalization, adaptability, and safety, particularly when applied to users with differing ages, health conditions, or comfort preferences.

Chinese Patent No. 113143749B discloses an acupoint massage device and a massage control method thereof. The device includes at least one master device and at least one slave device. The master device includes an acupoint carrier marked with a plurality of acupoint identifiers, a pressure sensing module, a first processing module, and a first communication module. Acupoint pressure data, generated when a user applies pressure to the acupoint identifiers, is collected via the pressure sensing module. The first processing module performs signal conversion and data analysis on the acupoint pressure data to generate a data packet. The first communication module transmits the data packet to the slave device corresponding to the pressing position information. The slave device parses pressure intensity information from the data packet and, based on the pressure intensity information, controls an acupoint actuator within the slave device to perform acupoint massage. In this manner, the master device controls the slave device to achieve massage control, which not only realizes single-point control of acupoints but also enhances the interactivity and user experience of the acupoint massager.

The technical field of Chinese Patent No. 113143749B is similar to that of the present disclosure. The patent includes a master device and a slave device, wherein the master device comprises an acupoint carrier with acupoint identifiers, a pressure sensing module, a first processing module, and a communication module. Signal processing is performed on pressure data collected via the pressure sensing module during acupoint pressing to generate a data packet transmitted to the corresponding slave device. After receiving the data packet, the slave device parses pressure intensity information and controls an actuator to implement precise massage on specific acupoints. Through the coordinated operation of the master and slave devices, the devices not only support single-point acupoint control but also improve massage interactivity and user experience.

U.S. Patent Application Publication No. 20240341874A1 discloses a system, method, and device for a robot system for autonomous treatment or processing of a body having soft tissue and/or hard tissue. A system, method, and device are provided for a robot control system with fused sensing streams for predicting a deformation model of a robot end-effector and the tissue contacted by the end-effector using, for example, Finite Element Analysis (FEA). Model updates provide adjustment parameters to the control system to compensate for the mechanical properties of the robot end-effector and changes in the characteristics and/or movement of the tissue processed by the robot end-effector.

The technical field of U.S. Patent Application Publication No. 20240341874A1 is similar to that of the present disclosure. The patent comprises a robot manipulator and a processor controller. By fusing sensing data, the deformation of the manipulator or the deformable body it contacts is predicted. Adjustment parameters are generated based on the deformation results to compensate for changes in mechanical properties or tissue characteristics, thereby enabling the robot manipulator to perform precise movement control based on the adjustment parameters for the autonomous processing or treatment of soft or hard tissues.

Chinese Patent Application Publication No. 106821718A discloses an all-intelligent scanning massage healthcare method and robot for dredging meridians. The massage device scans and detects the body of a subject to acquire acupoint information, determines massage points based on the acupoint information of the subject's body, and performs massage based on the massage points. Utilizing the all-intelligent scanning massage healthcare robot, effective massage, shiatsu, squeezing, vibration, tapping, thermal kneading, magnetic therapy, and red-light irradiation are performed on acupoints, meridians, and blood vessels throughout the human body. This can adjust meridians and internal organs, dredge acupoints, promote blood circulation, lymphatic circulation, and metabolism, regulate endocrine functions, enhance immunity, and adjust the nervous system, providing significant functions and efficacy for the prevention, treatment, and healthcare of various symptoms and aging.

The technical field of Chinese Patent Application Publication No. 106821718A is similar to that of the present disclosure. Acupoint information of the subject is acquired through a human detection scanning device. An intelligent control system determines massage points based on the acupoint information, and an execution mechanism and a drive system control a robotic hand to massage the designated acupoints. The device integrates multiple massage functions, including shiatsu, vibration, thermal kneading, magnetic therapy, and red-light irradiation, which can promote blood circulation, regulate endocrine functions, and enhance immunity for healthcare and disease prevention effects.

Chinese Patent No. 110347449B discloses an intelligent massage chair massage program recommendation optimization method and system. The steps include: 1) collecting personal information of a user; 2) obtaining an initial massage recommendation combination based on the personal information, wherein the massage recommendation combination includes a technique combination and adjustable parameters; 3) computing a correction amount based on historical evaluation data and adjusting the adjustable parameters based on the correction amount to obtain a final massage recommendation combination; 4) executing the final massage recommendation combination by a massage device; and 5) collecting the user's evaluation data and storing it in the historical evaluation data. The disclosure achieves an integrated closed loop of massage programs, user feedback, and analysis optimization, thereby continuously improving recommendation logic and providing a better massage experience.

The technical field of Chinese Patent No. 110347449B is different from that of the present disclosure. The patent collects personal information (such as soreness index, blood oxygen, heart rate, etc.) to generate an initial massage recommendation combination (including technique combinations and adjustable parameters). It computes correction amounts based on historical evaluation data to optimize the adjustable parameters. After forming the final recommendation combination, it is executed by the massage device.

Furthermore, user feedback data is stored in the historical evaluation data to achieve closed-loop optimization of the massage program and user feedback, enhancing the massage experience.

Taiwan Patent No. 1856922B discloses a massage teaching system and an operation mechanism method thereof. Based on the relationship between the muscle tissue stiffness of a subject and the massage force of a practitioner, the system is constructed in a systematic manner so that the practitioner can confirm the muscle stiffness of the subject, implement a specific massage force accordingly, and perform the relevant massage process. The disclosure establishes a feedback discrimination criterion for muscle tissue and a means for adjusting massage force, systematically completing a massage palpation system. Palpation is executed by detecting resistance changes between the practitioner's massage force and the muscle stiffness to capture an appropriate massage force. By quantifying muscle stiffness data, a baseline force value is provided to the practitioner, who then adjusts the massage force accordingly.

The technical field of Taiwan Patent No. 1856922B is similar to that of the present disclosure. Based on the interaction between the muscle stiffness of the subject and the force applied by the practitioner, sensors are used to quantify muscle stiffness data, establishing a muscle stiffness feedback criterion and a force adjustment mechanism. The system comprises functions for pressing and positioning teaching, resistance adjustment palpation teaching, and massage implementation teaching. Massage effects are determined through changes in resistance data, providing a baseline force value to guide the practitioner in adjusting pressing force, thereby achieving a systematic and precise massage teaching process.

U.S. Patent Application Publication No. 20250095647A1 discloses technical means for providing feedback based on descriptions from a subject. It does not provide a method for analysis and feedback based on numerical values from devices such as pressure sensors, strain gauges, or motor current sensors, which leads to biased feedback information.

U.S. Patent Application Publication No. 20220134551A1 discloses technical means for performing massage based on a massage scheme of a predetermined process. It does not provide a method for segmenting massage actions into primitives or a method for utilizing AI technology to generate a new massage scheme adapted to the subject.

U.S. patent Ser. No. 10/434,658B2 discloses technical means for analyzing massage position points based on visual recognition. It does not target the integration of other information (e.g., facial expressions of the subject) to collectively identify the real-time satisfaction of the subject regarding the massage scheme and massage actions. This causes a deviation in the understanding of the subject's satisfaction with various massage schemes and actions.

U.S. Patent Application Publication No. 20250269526A1 discloses analyzing massage positions based on body flexibility and tissues. The logic can be understood as identifying corresponding acupoints based on the body flexibility of various tissues. Consequently, different tissues may be erroneously identified as the same tissue, leading to the application of incorrect massage actions to the wrong tissues and positions.

U.S. Pat. No. 11,320,326B2 discloses hardware design for torque sensing. It is only capable of torque sensing and cannot perform pressure or tension sensing.

Accordingly, there exists a need for an intelligent massage system capable of recording dynamic massage information, generating personalized massage control parameters, and applying and dynamically adjusting massage forces through a physical force application assembly during massage execution.

### BRIEF SUMMARY OF THE DISCLOSURE

In view of the aforementioned drawbacks of the prior art, it is an objective of the disclosure to provide an intelligent massage system, a method for intelligent massage control, and another intelligent massage system.

In one aspect, the intelligent massage system comprises: a multi-modal sensing array configured to capture real-time dynamic data of a subject during a massage session, the real-time dynamic data including at least a pressure distribution, a force vector, and a three-dimensional (3D) trajectory of a massage movement; a plan construction module comprising a processor and an artificial intelligence (AI) engine, the AI engine configured to: derive a satisfaction evaluation metric based on the real-time dynamic data; dynamically analyze a health profile of the subject and the satisfaction evaluation metric; and generate a personalized massage protocol comprising a sequence of massage primitives and force parameters; an automated actuator configured to physically implement a massage protocol on the subject; and a real-time adjustment module operably coupled to the automated actuator and configured to: monitor a physiological state of the subject based on sensor signals from the multi-modal sensing array during execution of the personalized massage protocol; and dynamically modify at least one parameter of the personalized massage protocol based on a feedback control loop integrating the monitored physiological state and a pre-trained professional massage logic to generate a modified personalized massage protocol; wherein the automated actuator is configured to physically implement the modified personalized massage protocol on the subject. In short, the system utilizes an AI engine to derive a satisfaction evaluation metric and generate a personalized protocol, which is then dynamically modified during execution based on real-time physiological feedback and a professional massage logic.

In another aspect, the present disclosure provides an intelligent massage control method comprising: capturing, by a multi-modal sensing array, real-time dynamic data of a subject during a massage session, the dynamic data comprising at least a pressure distribution, a force vector, and a three-dimensional (3D) trajectory of a massage movement; dynamically analyzing, by a processor executing an artificial-intelligence-based algorithm, the dynamic data and subject information including a health profile and a satisfaction evaluation metric; generating, based on the analysis, a personalized massage protocol defining control instructions for an automated actuator for applying a massage force to the subject, the personalized massage protocol comprising a sequence of massage primitives and force parameters; applying, by the automated actuator, a massage force to the subject in accordance with the personalized massage protocol; monitoring, during execution of the personalized massage protocol, a physiological state of the subject based on sensor signals from the multi-modal sensing array; and dynamically modifying at least one parameter of the personalized massage protocol based on a feedback control loop integrating the monitored physiological state and a pre-trained professional massage logic, wherein the automated actuator physically implements the dynamically modified personalized massage protocol on the subject in real time.

In yet another aspect, the present disclosure provides an intelligent massage system, comprising: a massage information recording module configured to record dynamic massage information of a subject during execution of a massage operation, the massage information recording module comprising: a data collection unit configured to collect sensor signals from a plurality of sensors; a sensor interface unit electrically connected to the plurality of sensors; and a data storage unit configured to store massage data, wherein the massage data comprise at least pressure, applied force direction, and massage location associated with the subject during the massage operation; a massage technique and workflow construction module, comprising a processor executing an artificial-intelligence-based algorithm configured to dynamically analyze the massage data and subject information including age, health condition, and satisfaction evaluation, and to generate massage control parameters defining a personalized massage technique and workflow; a massage optimization and real-time adjustment module configured to, based on whole-body sensing and real-time feedback from the plurality of sensors, dynamically modify the massage control parameters during the massage operation using an artificial-intelligence technique; and a massage force application assembly configured to apply a controllable massage force to the subject in accordance with the massage control parameters, the massage force application assembly comprising at least one force transmission element and at least one drive element; wherein the plurality of sensors comprise at least a pressure sensing glove configured to detect pressure variations and force directions applied during the massage operation, and a depth camera configured to record motion details and three-dimensional movement trajectories to provide motion reproduction parameters, and wherein the massage force application assembly is controlled in real time based on the dynamically modified massage control parameters to adjust at least one of massage force magnitude, direction, timing, or application location during execution of the massage operation.

### BRIEF DESCRIPTION OF THE DRAWINGS

It should be noted that the drawing figures may be in simplified form and might not be of a precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a functional block diagram of an intelligent massage system according to the disclosure.

FIG. 2 is a flowchart illustrating an intelligent massage control method according to the disclosure.

FIG. 3 is a structural view of a strain gauge adhered to a pull rod of the intelligent massage system according to an embodiment of the disclosure.

FIG. 4 is a structural view of a tension sensor connected to a strap of the intelligent massage system according to an embodiment of the disclosure.

FIG. 5 is a structural view of the tension sensor connected to the strap of the intelligent massage system, viewed from another angle, according to an embodiment of the disclosure.

FIG. 6 is a schematic view of motor drive elements and force transmission elements of the intelligent massage system according to an embodiment of the disclosure.

FIG. 7 is a schematic view of the motor drive elements and force transmission elements of the intelligent massage system according to an embodiment of the disclosure.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

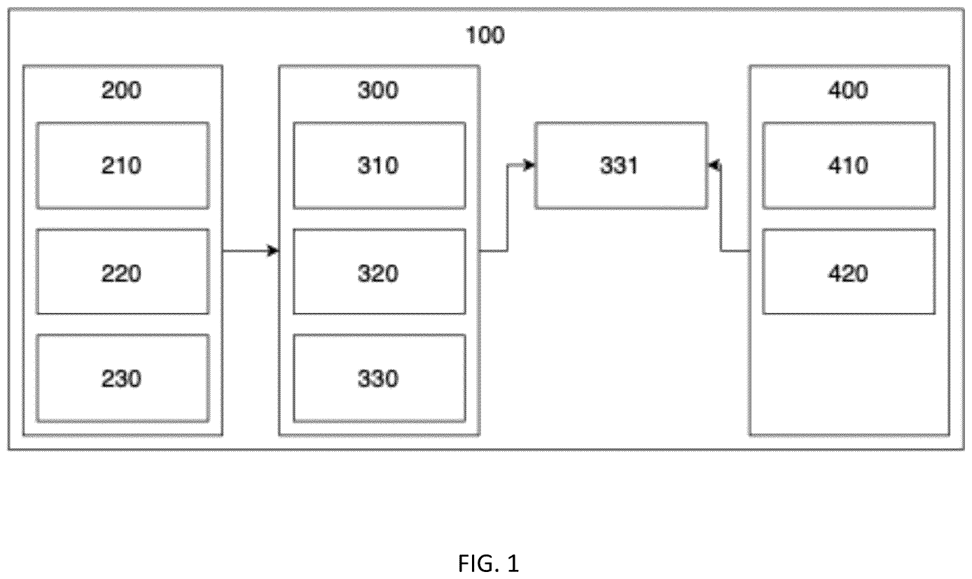

Referring to FIG. 1, an intelligent massage system 100 comprises a multi-modal sensing array (also referred to as a massage information recording module 200), a plan construction module (also referred to as a massage technique and workflow construction module 300), an automated actuator (also referred to as a bionic robot 331), and a real-time adjustment module (also referred to as a massage optimization and real-time adjustment module 400). The intelligent massage system 100 is configured to execute a massage operation while continuously sensing physical interaction between the massage system and a subject, analyzing sensed data using artificial intelligence, and dynamically adjusting applied massage forces in real time.

The multi-modal sensing array 200 comprises a data collection unit 210, a sensor interface unit 220, and a data storage unit 230. The sensor interface unit 220 is electrically connected to a multi-modal sensing array, which includes a pressure sensing glove and a depth camera.

The data collection unit 210 captures real-time dynamic data, including pressure distribution, force vectors, and 3D trajectories of massage movements, via the sensor interface unit 220. These data are stored in the data storage unit 230 as a historical massage data repository.

The plan construction module 300 comprises a processor and an artificial intelligence (AI) engine. Specifically, the plan construction module 300 includes a data analysis unit 310, an AI massage algorithm unit 320, and a massage scheme generation and execution unit 330. The processor is configured to implement the functions of the data analysis unit 310 and the massage scheme generation and execution unit 330. Furthermore, the AI engine is configured to execute the logic of the AI massage algorithm unit 320. The AI massage algorithm unit 320 executes an artificial-intelligence-based algorithm to process sensor-derived data. Rather than performing abstract mental evaluations, the AI engine is configured to derive control parameters by analyzing a health profile and a satisfaction evaluation metric. The massage scheme generation and execution unit 330 then generates a personalized massage protocol, which defines a sequence of massage primitives and force parameters for the automated actuator 331 operably coupled to and controlled by the plan construction module 300 and the real-time adjustment module 400.

In one embodiment, the AI massage algorithm unit 320 utilizes a Retrieval-Augmented Generation (RAG) architecture. As used herein, “RAG” refers to a technical framework where the system retrieves specific professional massage logic from the data storage unit 230 and integrates this retrieved data with real-time dynamic data from the sensors to output modified control signals.

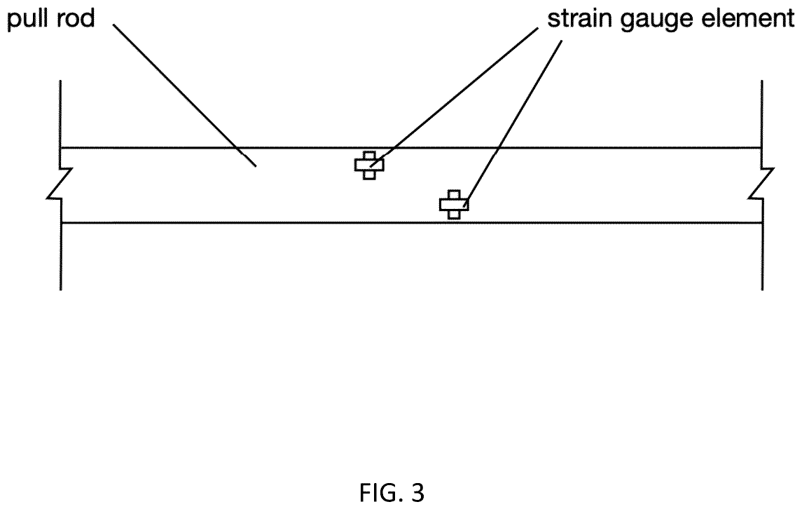

Referring to FIGS. 3-5, the system includes physical hardware for force application. A pulling-force sensing system is configured to detect tension via a strain gauge disposed on a pull rod or a tension sensor coupled to a strap. These physical sensors provide the inputs required for the feedback control loop. The automated actuator 331 physically implements the massage protocol using at least one front strap and at least one back strap to stabilize and apply massage force to the subject's body. Sensor signals generated by strain gauges, pulling-force sensors, current sensors, or other force-related hardware are transmitted to the AI algorithm as real-time feedback inputs. The AI algorithm evaluates discrepancies between commanded force parameters and measured physical force values to dynamically update massage control parameters. In embodiments employing elastic force transmission elements such as straps or compliant pull rods, tensile massage force may be derived from measured elongation. Specifically, tensile force F may be calculated according to:

$$F = k \cdot Δ x$$

where k is a stiffness coefficient associated with the force transmission element and Δx is a measured displacement obtained from a strain gauge or tension sensor. The calculated tensile force is supplied to the artificial-intelligence algorithm as a physical feedback variable used to dynamically update massage force magnitude, timing, or application location, whereas a pre-trained professional massage logic and historical massage data may be employed to improve safety, comfort, and effectiveness. In some embodiments, the artificial-intelligence algorithm updates internal model parameters based on cumulative physical force data collected from the massage force application assembly. Force measurements obtained from strain gauges, tension sensors, and motor current sensors are stored as training samples associated with corresponding massage primitives. These samples are used to refine force-prediction models and to adjust subsequent massage protocol generation, thereby enabling continuous learning grounded in real mechanical interaction with the subject.

In some embodiments, the force transmission elements include a pull rod coupled to a strain gauge configured to detect mechanical deformation corresponding to applied massage force. In embodiments in which the force transmission element comprises a torsional pull rod, the applied massage torque may be derived from measured angular deformation of the pull rod. Specifically, torque T applied to the pull rod may be calculated according to:

$$T = \frac{GJ θ}{L}$$

where G is a shear modulus of the pull rod material, J is a polar moment of inertia of the pull rod cross section, θ is an angular displacement measured by the strain gauge, and L is an effective length of the pull rod. The calculated torque value is provided as a quantitative force input to the artificial-intelligence algorithm to calibrate, limit, or modify massage control parameters in real time.

As mentioned before, output signals from the strain gauge are provided to the artificial-intelligence algorithm as quantitative force measurements. The AI algorithm correlates the measured strain-based force values with massage primitives and force-time profiles to refine force calibration, ensure safe force limits, and improve consistency between intended and applied massage forces. The massage force application assembly applies controllable massage forces to the subject in accordance with the massage control parameters and is dynamically adjusted in real time to modify force magnitude, direction, timing, or application location.

The real-time adjustment module 400 comprises a systemic detection unit 410 and an AI massage therapist system and real-time adjustment unit 420. The real-time adjustment module is configured to monitor a physiological state of the subject. This monitoring is facilitated by the systemic detection unit 410, which integrates data from the multi-modal sensing array 200 (e.g., sound sensors for sleep-state detection and cameras for facial expression analysis) to provide real-time feedback. If the monitored physiological state exceeds a predefined safety threshold, the AI massage therapist system and real-time adjustment unit 420 outputs control signals to the automated actuator 331 to interrupt or reduce the massage force. In some embodiments, predefined safety thresholds are derived from physical limits of the force transmission elements and sensing hardware. When force measurements from a strain gauge, tension sensor, or current sensor exceed a corresponding threshold, the artificial-intelligence algorithm automatically modifies, limits, or interrupts execution of the massage protocol.

The real-time adjustment module 400 integrates whole-body sensing and real-time feedback to dynamically modify massage control parameters during execution of the massage operation. In some embodiments, the real-time adjustment module 400 establishes a direct computational linkage between the artificial-intelligence algorithm and one or more physical force-sensing components of the massage force application assembly.

The automated actuator 331 is configured to physically implement a massage protocol. As shown in FIG. 1, the automated actuator 331 is operably coupled to and controlled by the plan construction module 300 and the real-time adjustment module 400. In a specific embodiment, the automated actuator 331 is mechanically coupled to a massage force application assembly via a safety torque limiter, wherein the automated actuator 331 drives the massage force application assembly to apply a massage force to the subject. In the event that the sensed resistance from the subject's tissue exceeds a safety threshold (e.g., due to sudden movement or muscle spasm), the real-time adjustment module 400 initiates an emergency “release” massage primitive, instantly withdrawing the automated actuator 331 to a neutral position to prevent injury.

For example, when the systemic detection unit 410 captures an acoustic signal via a sound sensor, the AI engine processes this signal to determine a sleep state. Upon identifying a sleep state, the AI massage therapist system and real-time adjustment unit 420 iteratively adjusts control parameters to switch the automated actuator 331 to a “sleep-mode” protocol, characterized by reduced force parameters and modified massage primitives. Accordingly, the AI massage therapist system and real-time adjustment unit 420 is configured to execute a feedback control loop that integrates the monitored physiological state with a pre-trained professional massage logic to dynamically modify the personalized massage protocol.

As used herein, the term “AI massage therapist system” refers to a control interface executing the pre-trained professional massage logic and does not imply human cognition.

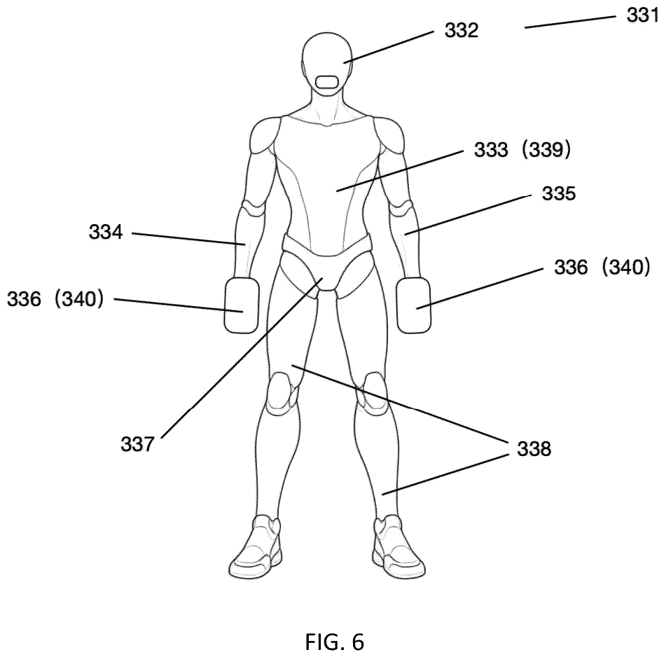

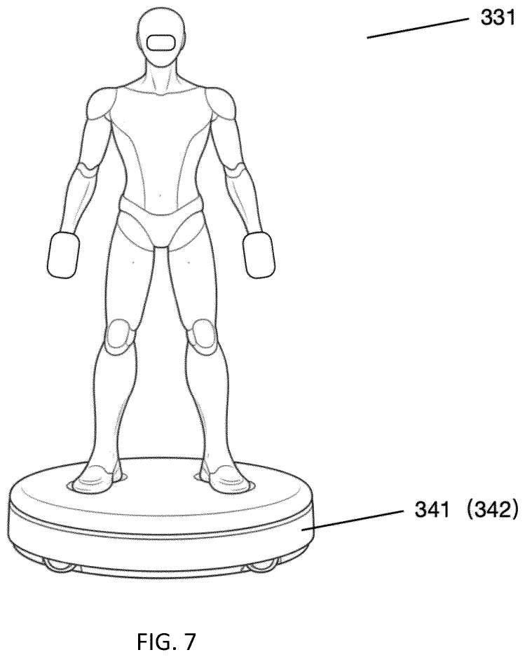

Referring to FIGS. 6-7, the automated actuator 331 includes a motor operably coupled to a force transmission element (e.g., a strap or pull rod). A current sensor monitors the electrical current supplied to the motor to infer the applied massage force. This electrical feedback is integrated into the feedback control loop to ensure the physical implementation of the massage force aligns with the personalized massage protocol.

Through the integration of the multi-modal sensing array, the RAG-based AI engine, and the automated actuator 331, the system 100 transforms multi-modal sensor inputs-including pressure distribution, 3D trajectories, and acoustic signals-into specific mechanical control signals. This technical configuration ensures that the physical implementation of the massage force is terminated based on the physical relaxation state of the subject's musculature.

In a specific embodiment, the systemic detection unit 410 is configured to acquire acoustic data from the subject, for example, using a sound sensor disposed within the multi-modal sensing array. The AI massage therapist system and real-time adjustment unit 420 processes these acoustic signals using a convolutional neural network (CNN) and a recurrent neural network (RNN) to differentiate between normal respiration and snoring. Upon computing a sleep-state classification, the AI massage therapist system and real-time adjustment unit 420 outputs modified control signals to the automated actuator 331 to transition the current personalized massage protocol to a sleep-mode protocol, thereby altering the mechanical implementation of the massage force.

In another specific embodiment, upon the systemic detection unit 410 identifying an acoustic frequency signature corresponding to a sleep state, the real-time adjustment module 420 executes a safety transition protocol. This protocol comprises: (i) gradually reducing the output force of the automated actuator 331 by 20-30%; (ii) transitioning from a “kneading” massage primitive to a “sustained pressure” massage primitive; and (iii) deactivating infrared irradiation to prevent overheating while maintaining red-light irradiation for continued cellular stimulation.

Furthermore, the systemic detection unit 410 is configured to acquire image data from a motion capture camera. The AI engine processes facial expression data from the image data to derive a satisfaction evaluation metric. Rather than performing a mental “judgment,” the system utilizes this metric to iteratively adjust the massage control parameters. For example, if the derived satisfaction metric indicates discomfort, the real-time adjustment module 400 generates an updated force-time profile for the automated actuator 331, resulting in an immediate physical reduction of the massage force magnitude applied by the straps.

The systemic detection unit 410 further comprises pressure sensors configured to monitor the physiological state related to muscle tension in a target massage region. The AI engine receives these tension measurements as input features. When the monitored physiological state (e.g., muscle tension) falls below a predefined relaxation threshold, the real-time adjustment module 400 outputs an end-of-session command to the motor of the automated actuator 331. This technical configuration ensures that the physical implementation of the massage force is terminated based on the physical relaxation state of the subject's musculature.

The AI massage algorithm unit 320 further optimizes the physical force application by integrating historical massage data and subject-specific information. In some embodiments, a stored health profile is processed to derive safe operating ranges for the automated actuator 331. By combining these pre-trained professional massage logics with real-time feedback from the strain gauges and tension sensors, the feedback control loop continuously regulates the current supplied to the motor, ensuring the applied massage force vector is technically optimized for the subject's real-time physical requirements.

The Retrieval-Augmented Generation (RAG) architecture of the AI engine ensures that the generated protocols are not based solely on abstract inferences but are grounded in a repository of predefined constraint rules and force-measurement data. Every adjustment to the massage primitives, motion trajectories, or force parameters made by the AI engine results in a corresponding change in the electrical output to the drive elements, thereby achieving a precise technical control of the massage force application assembly. In some embodiments, surface interaction between the massage force application assembly and the subject is further evaluated using a friction coefficient. The friction coefficient μ may be calculated using the formula:

$$μ = \frac{F}{N}$$

where F denotes a tangential massage force derived from strain or tension sensing and N denotes a normal force applied to the subject.

The calculated friction coefficient is used by the artificial-intelligence algorithm to detect abnormal slippage or excessive surface resistance and to adjust Massage Force Direction, magnitude, or contact trajectory to improve safety and comfort. This hardware-grounded safety mechanism ensures that massage force remains within mechanically verifiable bounds independent of purely software-based predictions.

The intelligent massage system 100 transforms multi-modal sensor inputs-including pressure distribution, 3D trajectories, and acoustic signals-into specific mechanical control signals. The integration of the feedback control loop and the AI-based processing modules provides a technical solution to the problem of non-adaptive automated massage, resulting in a physically implemented massage protocol that is dynamically and safely synchronized with the subject's physiological state.

The pulling-force sensing system is further configured to compute force vectors based on a coordinate relationship between the multi-modal sensing array and the subject's body surface. As detailed in Table 1 below, the system utilizes a depth camera to generate a three-dimensional point cloud of the subject and the operator. The real-time adjustment module 400 computes a motion vector (D) for the massage movement and a local surface normal vector (N) for the target massage region.

Another embodiment of the present disclosure is described below.

Regarding the collection of subject feedback information, the data collection unit 210 may comprise:
1. An online interactive platform providing digital forms accessible on mobile devices or tablets, through which the subject can submit satisfaction ratings and suggestions regarding the massage experience; and
2. A physical interactive interface configured to obtain feedback submitted by the subject via devices such as a touch screen.

Embodiments of the aforementioned multi-modal sensing devices may comprise the following hardware sensing devices and systems: a pressure sensing glove, a depth camera, a tension sensing system, a force sensing sheet, a strap, a motor, a current sensor, and a friction and tactile sensor.
1. Pressure sensing glove: capture pressure changes and force directions of the palm, fingertips, and the overall hand during the massage process, and transmit the data to the data collection unit.
2. Depth camera: record the details of the practitioner's actions and the operational trajectory in 3D space, and provide parameters for complete action reproduction.
3. Tension sensing system: work in conjunction with a pressure sensor and a pull rod to record stretching and twisting actions involved in the massage process. The implementation of the tension sensing system is illustrated in Table 1, using a depth camera to obtain the 3D position of the practitioner's hand relative to the subject's body surface and surface normal information, thereby determining whether the force direction is “pushing force” or “tension” and calculating the angle of the force direction relative to the subject's body surface. Alternatively, the system may measure the axial “pushing force” or “tension” of the pull rod through at least one strain gauge forming a Wheatstone bridge. Furthermore, a torque sensor may be installed at the rotation axis of the pull rod to measure the torque value when the pull rod is twisted; alternatively, the torque value may be estimated by identifying the position or angular change of markers placed on the subject's clothing via the depth camera. Additionally, the torque value when the pull rod is twisted can be measured via at least one strain gauge forming a Wheatstone bridge. Referring to FIG. 3, at least one strain gauge is adhered to the upper and lower surfaces of the pull rod in a cross arrangement (±45° alignment). The strain gauge includes an adhesive base layer and an outer protective layer and measures the torque value when the pull rod is twisted.

TABLE 1
Force Vector and Torque Calculation

| | Item | Description |
|---|---|---|
| System | Depth Camera | Utilize a depth camera (such as Intel RealSense |
| Composition | | or similar technology) to acquire scene depth |
| and Principle | | information comprising the subject’s body |
| | | surface and the practitioner’s hands to generate a |
| | | 3D point cloud of the scene. |
| | Hand Positioning and | Utilize depth images and computer vision |
| | Tracking | algorithms to detect and track the position of the |
| | | practitioner’s hands in 3D space. Acquire a hand |
| | | motion vector (D) from sequential frames, |
| | | representing the primary movement direction of |
| | | the applied force. |
| | Subject Body Surface | Convert the depth information of the subject’s |
| | Normal Vector | body surface into a point cloud or 3D mesh |
| | Calculation | model. Perform local surface fitting or utilize a |
| | | normal vector estimation algorithm at the hand |
| | | contact or approach area to obtain the surface |
| | | normal vector (N) of the area. The normal vector |
| | | N denotes the vertical direction of the surface |
| | | area and is used to determine whether the applied |
| | | force is inward (pushing) or outward (pulling). |
| Pushing | Pushing Force | If the hand motion vector D and the surface |
| Force, | Determination | normal vector N are substantially in the same |
| Tension, and | | direction (and oriented toward the interior of the |
| Torque | | subject’s body), it indicates the hand is applying |
| Determination | | force toward the interior of the subject's body, |
| Mechanisms | | defined as “pushing force.” |
| | Tension Determination | If the hand motion vector D and the surface |
| | | normal vector N are in opposite directions or |
| | | oriented from the inside out, it indicates the hand |
| | | is pulling the subject's body surface tissue |
| | | outward, defined as “tension.” |
| | Torque Determination | Implemented via three methods: |
| | | 1. Measuring a torque T when the pull rod is |
| | | twisted using a torque sensor (including a |
| | | rotating torque shaft or flange torque meter). |
| | | The torque T is calculated based on the physical |
| | | properties of the pull rod using the formula: |
| | | $T = \frac{GJ θ}{L}$ |
| | | where T denotes torque, G denotes shear |
| | | modulus, J denotes polar moment of inertia, and |
| | | θ denotes the torsion angle (angle of twist), and L |
| | | denotes the length of the rod segment. |
| | | 2. Markers are disposed on the clothing (e.g., |
| | | tight-fitting garments) worn by the subject. The |
| | | depth camera is configured to identify the |
| | | position or angular changes (e.g., relative angular |
| | | displacement) of the markers. Based on these |
| | | identified changes, the system estimates the |
| | | torque value applied to the subject’s body. |
| | | 3. At least one strain gauge is adhered to the |
| | | upper and lower surfaces of the pull rod in a |
| | | cross-pattern (aligned at ±45°). The torque value |
| | | generated is measured when the pull rod is |
| | | twisted by detecting the resulting strain through |
| | | the strain gauge configuration. |
| Acquisition of | Angle Calculation | The vector dot product formula is used to |
| Applied Force | Principle | calculate the included angle θ between the motion |
| Angle | | vector D and the surface normal vector N as |
| | | follows: |
| | | $θ = {cos}^{- 1} ( \frac{D \cdot N}{‖ D ‖ ‖ N ‖} )$ |
| | Interpretation of Angle | θ approaching 0°: The direction of the applied |
| | | force is substantially perpendicular to the surface |
| | | and oriented inward toward the subject’s body, |
| | | which is defined by the system as “pushing |
| | | force.” |
| | | θ approaching 180°: The direction of the applied |
| | | force is opposite to the surface normal vector |
| | | (oriented outward from the subject’s body), |
| | | which is defined by the system as “tension.” |
| | | θ approximately at an intermediate value (e.g., |
| | | 90°): The hand is sliding along the body surface |
| | | or applying lateral force. |

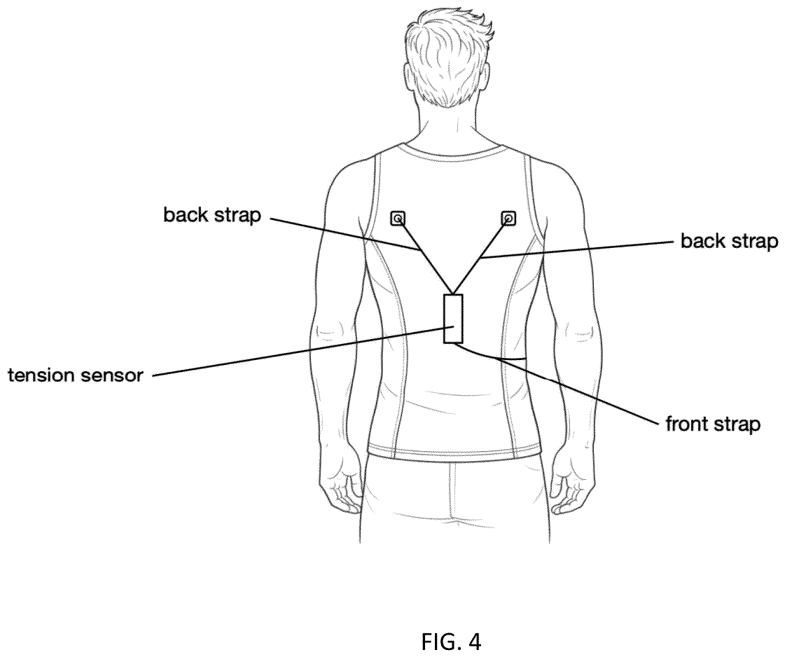

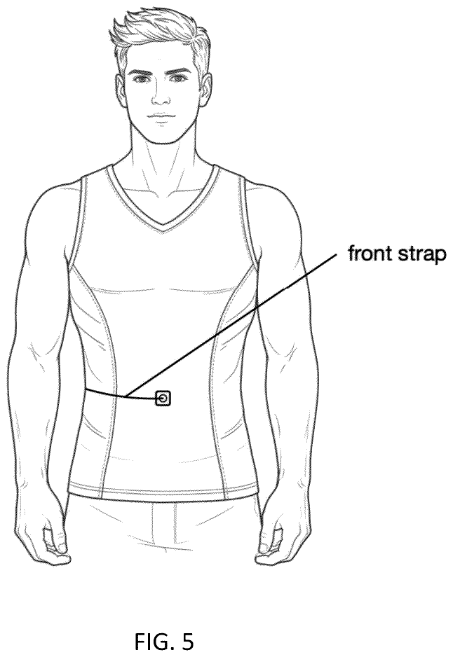

4. Force sensing sheet: The force sensing sheet is configured to detect contact force magnitudes at multiple locations on the surface of the subject's skin. Optionally, a thin-film force sensing sheet may be selected for integration with a massage device to mitigate any foreign-body sensation for the subject.
5. Strap: Referring to FIGS. 4 and 5, elastic materials such as straps are utilized, with a tension sensor coupled to a fixed end of the strap. The tension sensor measures tension (tractive tension) along the longitudinal axis of the strap, which can be calculated using the formula:

$$F = k \cdot Δ x$$

where k denotes the spring constant and Δx denotes the displacement (elongation).

In one embodiment, the configuration comprises three straps (two back straps and one front strap) coupled to a tension sensor, whereby the tension sensor measures the tension values of each strap to achieve multi-directional tension measurement.
6. Motor and current sensor: Through the motor and the current sensor, the current sensor monitors current variations in real time to calculate the magnitude of the counter-force (reaction force) currently opposed by the motor. The magnitude of the counter-force reflects the muscle tension level of the user.
7. Friction and tactile sensor: Through the friction and tactile sensor (electronic skin), the normal pressure and tangential shear force at the contact interface are monitored in real time to calculate changes in the friction force magnitude. The friction force can be determined using the formula:

$$μ = \frac{F}{N}$$

where F denotes the shear force measured at the onset of sliding and N denotes a normal pressure applied to the subject.

If an abnormal increase in u is detected, a stick-slip phenomenon (where excessive friction force causes difficulty in sliding) is inferred; conversely, if u is excessively low, it is inferred that the interface is over-lubricated and prone to slipping.

As illustrated in Table 1 and subsequent tables, at least one massage primitive may include, but are not limited to: (i) a contact/pre-load primitive, (ii) a pressing primitive, and (iii) a sustained pressure primitive.

Furthermore, regarding the embodiments of critical parameters acquired after the data collection unit 210 of the massage information recording module 200 is connected to the multi-modal sensing devices, the following settings are provided as an illustrative example:
1. Recording Frequency: 30 sets of critical parameters are recorded, with one set of critical parameters recorded every 15 seconds. The frequency is consistent for both the subject and the practitioner.
2. Item: Pressing of the neck and shoulders.
3. Subject Posture: Prone position (lying down).
4. Coordinate Setting: The vertex (0, 0, 0) is defined at the head opening of the massage table.
5. Field Settings:
(1) Year/Month/Day
(2) Practitioner ID
(3) Subject ID
(4) Massage Duration
(5) Subject Requirements
(6) Massage Body Part
(7) Massage Force Direction
(8) massage force magnitude (KG)
(9) Massage Coordinates
(10) Time (HH:MM:SS)

The critical parameters thus generated are recorded in Table 2 below, which comprises information from all aforementioned fields to serve as the data source for subsequent modules.

TABLE 2

| | | | | | | | Massage | | |
|---|---|---|---|---|---|---|---|---|---|
| | | | | Subject | Massage | Massage | Force | | |
| Year/ | Practi- | Subject | Massage | Require- | Body | Force | Magnitude | Massage | Time |
| Month/Day | tioner ID | ID | Duration | ments | Part | Direction | (KG) | Coordinates | (HH:MM:SS) |
| 2024 Nov. 22 | A001 | C001 | 30 | neck and | left | downward | 3 | (−10, | 0:00:00 |
| | | | minutes | shoulder | shoulder | | | 5, −2) | |
| | | | | pain | | | | | |
| 2024 Nov. 22 | A001 | C001 | 30 | neck and | left | inward | 3.2 | (−9.5, | 0:00:15 |
| | | | minutes | shoulder | shoulder | | | 5.5, −2.1) | |
| | | | | pain | | | | | |
| 2024 Nov. 22 | A001 | C001 | 30 | neck and | left | downward | 3.1 | (−9.8, | 0:00:30 |
| | | | minutes | shoulder | shoulder | | | 5.3, −2.0) | |
| | | | | pain | | | | | |
| 2024 Nov. 22 | A001 | C001 | 30 | neck and | neck | upward | 2.8 | (−8.5, | 0:00:45 |
| | | | minutes | shoulder | (left) | | | 6.0, 0.0) | |
| | | | | pain | | | | | |
| 2024 Nov. 22 | A001 | C001 | 30 | neck and | neck | inward | 2.9 | (−8.3, | 0:01:00 |
| | | | minutes | shoulder | (left) | | | 6.1, 0.1) | |
| | | | | pain | | | | | |
| 2024 Nov. 22 | A001 | C001 | 30 | neck and | right | downward | 3.2 | (10, | 0:01:15 |
| | | | minutes | shoulder | shoulder | | | 5, −2) | |
| | | | | pain | | | | | |
| 2024 Nov. 22 | A001 | C001 | 30 | neck and | right | inward | 3.3 | (9.7, | 0:01:30 |
| | | | minutes | shoulder | shoulder | | | 5.5, −2.1) | |
| | | | | pain | | | | | |
| 2024 Nov. 22 | A001 | C001 | 30 | neck and | right | downward | 3.1 | (9.8, | 0:01:45 |
| | | | minutes | shoulder | shoulder | | | 5.3, −2.0) | |
| | | | | pain | | | | | |
| 2024 Nov. 22 | A001 | C001 | 30 | neck and | neck | upward | 2.9 | (8.5, | 0:02:00 |
| | | | minutes | shoulder | (right) | | | 6.0, 0.0) | |
| | | | | pain | | | | | |
| 2024 Nov. 22 | A001 | C001 | 30 | neck and | neck | inward | 3 | (8.3, | 0:02:15 |
| | | | minutes | shoulder | (right) | | | 6.1, 0.1) | |
| | | | | pain | | | | | |
| 2024 Nov. 22 | A001 | C001 | 30 | neck and | left | downward | 3 | (−10, | 0:02:30 |
| | | | minutes | shoulder | shoulder | | | 5, −2) | |
| | | | | pain | | | | | |
| 2024 Nov. 22 | A001 | C001 | 30 | neck and | left | inward | 3.2 | (−9.5, | 0:02:45 |
| | | | minutes | shoulder | shoulder | | | 5.5, −2.1) | |
| | | | | pain | | | | | |
| 2024 Nov. 22 | A001 | C001 | 30 | neck and | left | downward | 3.1 | (−9.8, | 0:03:00 |
| | | | minutes | shoulder | shoulder | | | 5.3, −2.0) | |
| | | | | pain | | | | | |
| 2024 Nov. 22 | A001 | C001 | 30 | neck and | neck | upward | 2.8 | (−8.5, | 0:03:15 |
| | | | minutes | shoulder | (left) | | | 6.0, 0.0) | |
| | | | | pain | | | | | |
| 2024 Nov. 22 | A001 | C001 | 30 | neck and | neck | inward | 2.9 | (−8.3, | 0:03:30 |
| | | | minutes | shoulder | (left) | | | 6.1, 0.1) | |
| | | | | pain | | | | | |
| 2024 Nov. 22 | A001 | C001 | 30 | neck and | right | downward | 3.2 | (10, | 0:03:45 |
| | | | minutes | shoulder | shoulder | | | 5, −2) | |
| | | | | pain | | | | | |
| 2024 Nov. 22 | A001 | C001 | 30 | neck and | right | inward | 3.3 | (9.7, | 0:04:00 |
| | | | minutes | shoulder | shoulder | | | 5.5, −2.1) | |
| | | | | pain | | | | | |
| 2024 Nov. 22 | A001 | C001 | 30 | neck and | right | downward | 3.1 | (9.8, | 0:04:15 |
| | | | minutes | shoulder | shoulder | | | 5.3, −2.0) | |
| | | | | pain | | | | | |
| 2024 Nov. 22 | A001 | C001 | 30 | neck and | neck | upward | 2.9 | (8.5, | 0:04:30 |
| | | | minutes | shoulder | (right) | | | 6.0, 0.0) | |
| | | | | pain | | | | | |
| 2024 Nov. 22 | A001 | C001 | 30 | neck and | neck | inward | 3 | (8.3, | 0:04:45 |
| | | | minutes | shoulder | (right) | | | 6.1, 0.1) | |
| | | | | pain | | | | | |

Furthermore, regarding the embodiments of critical parameters acquired by the data collection unit 210 of the massage information recording module 200 via an online interactive platform or physical interactive interface, the following settings are provided as an illustrative example:
1. Recording Frequency: One set of critical parameters is recorded daily. In this embodiment, the data is collected for the same subject across different practitioners (e.g., practitioners A001 through A004).
2. Field Settings:
(1) Year/Month/Day
(2) Practitioner ID
(3) Subject ID
(4) Massage Duration
(5) Subject Requirements
(6) Subject's Satisfied Areas
(7) Subject's Dissatisfied Areas

The critical parameters thus generated are recorded in Table 3 below, which comprises all the aforementioned field information, including the subject's satisfied areas and dissatisfied areas, and serves as the data source for subsequent modules.

TABLE 3

| | Practi- | | | | | Subject's | Subject's |
|---|---|---|---|---|---|---|---|
| Year/ | tioner | Subject | Massage | | Subject | Satisfied | Dissatisfied |
| Month/Day | ID | ID | Duration | | Requirements | Areas | Areas |
| 2024 Nov. 1 | A001 | C001 | 30 | minutes | neck and | left | N/A |
| | | | | | shoulder pain | shoulder | |
| 2024 Nov. 2 | A002 | C001 | 1 | hour | waist stiffness | waist | left leg |
| 2024 Nov. 3 | A003 | C001 | 30 | minutes | back | back | right shoulder |
| | | | | | discomfort | (middle) | |
| 2024 Nov. 4 | A001 | C001 | 30 | minutes | neck and | neck | N/A |
| | | | | | shoulder pain | (right) | |
| 2024 Nov. 5 | A004 | C001 | 1 | hour | full-body | waist | N/A |
| | | | | | relaxation | | |
| 2024 Nov. 6 | A002 | C001 | 30 | minutes | waist | N/A | left leg |
| | | | | | tightness | | |
| 2024 Nov. 7 | A003 | C001 | 1 | hour | back stiffness | back | waist |
| | | | | | | (middle) | |
| 2024 Nov. 8 | A001 | C001 | 30 | minutes | neck and | left | neck (left) |
| | | | | | shoulder pain | shoulder | |
| 2024 Nov. 9 | A004 | C001 | 1 | hour | waist | waist | back (lower) |
| | | | | | soreness | | |
| 2024 Nov. 10 | A002 | C001 | 30 | minutes | back stiffness | N/A | right leg |
| 2024 Nov. 11 | A003 | C001 | 1 | hour | full-body | back | N/A |
| | | | | | relaxation | (middle) | |
| 2024 Nov. 12 | A001 | C001 | 30 | minutes | neck and | N/A | N/A |
| | | | | | shoulder pain | | |
| 2024 Nov. 13 | A004 | C001 | 1 | hour | leg fatigue | left leg | right leg |
| 2024 Nov. 14 | A002 | C001 | 30 | minutes | waist stiffness | N/A | back (upper) |
| 2024 Nov. 15 | A003 | C001 | 1 | hour | back soreness | back | waist |
| | | | | | | (middle) | |
| 2024 Nov. 16 | A001 | C001 | 30 | minutes | neck and | neck (left) | right shoulder |
| | | | | | shoulder pain | | |
| 2024 Nov. 17 | A004 | C001 | 1 | hour | full-body | waist | N/A |
| | | | | | relaxation | | |
| 2024 Nov. 18 | A002 | C001 | 30 | minutes | waist | waist | right leg |
| | | | | | soreness | | |
| 2024 Nov. 19 | A003 | C001 | 1 | hour | back stiffness | back | N/A |
| | | | | | | (middle) | |
| 2024 Nov. 20 | A001 | C001 | 30 | minutes | neck and | N/A | left shoulder |
| | | | | | shoulder pain | | |

The massage technique and workflow construction module 300 utilizes AI technology to dynamically analyze and optimize the acquired subject massage information. Based on the personalized requirements of the subject, the module generates an optimal massage process and technique scheme, which is precisely implemented via multi-modal hardware devices. The massage technique and workflow construction module 300 may be implemented in a systematic architecture, an operational embodiment of which is described below:

Module System Architecture and Operational Embodiment: The massage technique and workflow construction module 300 may be an integrated hardware-software system. Its architecture comprises a data analysis unit 310, an AI massage algorithm unit 320, and a massage scheme generation and execution unit 330. The data analysis unit 310 is configured to receive dynamic information and perform filtering and weight calculations based on the dynamic information. The AI massage algorithm unit 320 dynamically analyzes the dynamic information through a satisfaction evaluation and time weight to generate an optimal massage instrument and technique scheme. The massage scheme generation and execution unit 330 generates a complete massage process according to the calculation results of the AI massage algorithm unit 320.
1. Data analysis unit 310: configured to receive and organize customer data, including age, health status, historical massage records, and satisfaction levels, provided by the massage information recording module 200. The data analysis unit 310 performs manual labeling of video images via tools comprising OTRS (Operation, Time, Resource, and Sequence analysis tool) after video recording, or performs automated labeling via AI recognition. The resulting data serves as the core computational input for the subsequent AI massage algorithm unit 320. The unit further performs filtering and weight calculations based on the data source to ensure the generated scheme meets the latest requirements of the customer.
2. AI massage algorithm unit 320: configured to analyze individual case data utilizing artificial intelligence (AI). The unit maps the massage actions represented in the critical parameter records and decomposes the massage actions into at least one massage primitive (also referred to herein as a technique primitive) according to a force-time curve and an action trajectory sequence. In one embodiment, the massage actions are decomposed into three technique primitives: “pressing,” “release,” and “sliding.” The unit dynamically adjusts the selection of massage instruments, technique planning, and process steps to iteratively optimize a personalized massage scheme. Table 4 below illustrates an embodiment of the results of decomposing massage actions into technique primitives.

Each massage primitive is defined by a specific force-time curve. For example, a “pressing” primitive follows a trapezoidal force profile where the force increases linearly for t1, maintains a peak pressure Pmax for t2, and releases gradually over t3. The AI massage algorithm unit 320 optimizes these t-parameters based on the subject's body mass index (BMI) and historical massage data.

TABLE 4

| | Description | Force-Time | | | Clinical |
|---|---|---|---|---|---|
| | of | Curve & Action | | Practitioner's | Utility in |
| Technique | Technique | Trajectory | Setting | Anatomical | Massage |
| Primitive | Primitive | Sequence | Parameters | Region | Scheme |
| contact/pre- | gentle | gradual force | contact | palm, forearm | initial entry; |
| load | engagement | increase; | area; | | tension |
| | to | low peak force | approach | | detection |
| | establish | | velocity | | |
| | tactile | | | | |
| | safety | | | | |
| probe/scan | light touch | continuous | velocity | finger pads, | assessment; |
| | traversal to | movement with | (cm/s); | palm | navigation |
| | identify | low force | path | | |
| | tightness | | | | |
| | points | | | | |
| pressing | vertical | gradual | peak | thumb, | relief of |
| | compression | rise→short | force; | thenar/hypo- | tightness, |
| | of soft | peak→release | dwell | thenar | analgesia |
| | tissue | | time | eminence, | |
| | | | (seconds) | elbow | |
| sustained | maintaining | gradual | plateau | thumb, elbow | trigger point |
| pressure | constant | rise→plateau | duration; | | therapy |
| | pressure | (5-60s)→gradual | plateau | | |
| | on trigger | fall | force | | |
| | points | | | | |
| release | withdrawal | smooth force | force | any | soothing |
| | from | reduction | reduction | | neurological |
| | pressure | | slope | | response |
| | application | | | | |
| sliding | superficial | low force; | velocity; | palm, forearm | promoting |
| | long- | stable velocity | path | | circulation, |
| | stroke | | length | | transition |
| | movement | | | | |
| kneading | alternating | periodic | frequency | finger pads, | relaxing |
| | lifting and | fluctuations | (Hz); | palm | superficial |
| | squeezing | | amplitude | | muscles |
| pushing/ | long stroke | moderate force; | velocity; | thumb, | myofascial |
| stripping | along | constant | path; | forearm | release |
| | muscle | velocity | angle | | |
| | fibers | | | | |
| friction | small- | high friction; | amplitude | fingertips, | adhesion |
| | amplitude | short-amplitude | (mm); | knuckles | treatment |
| | transverse | reciprocation | frequency | | |
| | shearing | | (Hz) | | |
| rolling | rolling- | periodic; large | contact | forearm, tool | large-area |
| | style | contact area | area; | roller | relaxation |
| | squeezing | | velocity | | |
| vibration | high- | sinusoidal or | frequency | palm, | analgesia, |
| | frequency, | noise-type | (5-60 Hz) | mechanical | arousal or |
| | low- | waveform | | head | relaxation |
| | amplitude | | | | |
| | oscillation | | | | |
| percussion | rhythmic | pulse train | frequency; | cupped palm; | activation; |
| | tapping | | intensity | fist | pre- |
| | | | | | movement |
| | | | | | prep |
| rocking/shaking | low- | low force; | frequency; | both hands | reducing |
| | frequency | constant | direction | | muscle |
| | oscillation | amplitude | | | guarding; |
| | | | | | soothing |
| stretching | passive | gradual | angle; | both hands, | increasing |
| | extension | rise→hold→release | hold | straps | ROM; |
| | of tendons | | duration | | relaxation |
| | | | (seconds) | | |
| joint | small- | low force; | grades | both hands | joint sliding |
| mobilization | amplitude | graded | I-IV; | | |
| | joint | | frequency | | |
| | oscillation | | | | |
| traction/ | stretching | stable | tension | both hands, | decompression |
| distraction | axially | tension→release | magnitude; | slings/straps | |
| | | | duration | | |
| pinch- | lifting of | gripping→short | pinching | thumb and | improving |
| lifting/skin | subcutaneous | hold→release | force; | index finger | myofascial |
| lifting | tissue | | rhythm | | gliding |

The AI massage algorithm unit 320 may be implemented via a system architecture comprising the following components:

Data Processing: Configured to utilize Python-based libraries, such as Pandas, NumPy, or a combination thereof. Specifically, for the data processing involving the decomposition of massage actions into at least one technique primitive, Retrieval-Augmented Generation (RAG) technology and Large Language Models (LLMs) are employed to analyze and decompose each massage action into constituent technique primitives.

AI Training Frameworks: Comprising machine learning frameworks such as TensorFlow, PyTorch, Scikit-learn, or a combination thereof.

Algorithms: Utilizing algorithms including, but not limited to, Random Forest, Gradient Boosting Trees, K-means clustering, or a combination thereof.

The operational characteristics of the AI massage algorithm unit 320 are as follows:

Integration of satisfaction and time weights: Utilizing Long Short-Term Memory (LSTM) network technology to perform weight processing on recent massage data, or assigning priority (high-level) tags to the subject's satisfied areas and dissatisfied areas, thereby ensuring the scheme adapts to the latest requirements.

Generation of complete massage process parameters: Comprising force control, action sequences, and action constraints (e.g., restricted zone specifications), including the generation of complete massage process parameters.

The system provides mode selection capabilities, allowing for the adjustment of the primary operational mode of the AI massage algorithm based on specific objectives or requirements to enhance targeted outcomes. Mode selection comprises the following:
A. Supervised Learning Mode: This mode utilizes algorithms such as Random Forest, Gradient Boosting Trees, or a combination thereof, to train models that predict which massage techniques will most effectively alleviate discomfort in specific anatomical regions. The predictive analysis is performed based on aggregated historical data.
B. Unsupervised Learning Mode: This mode utilizes algorithms such as K-means clustering to identify the subject's underlying affinities for specific practitioners or massage techniques.

Massage scheme generation and execution unit 330: Based on the complete massage process parameters output by the AI massage algorithm unit 320, and by utilizing technique primitives together with the complete massage process parameters, a massage scheme suitable for customer needs is generated and provided to an operation terminal or automated equipment for execution. In an embodiment, if the cause of the subject's discomfort is located in the back muscles and soothing massage is required, the massage scheme generation and execution unit 330 may generate massage actions composed of two technique primitives—“small range” and “more focused”—to form thumb-based point-pressing massage actions, as well as massage actions composed of two technique primitives—“large range” and “deeper pressure”—to form forearm or elbow pressing massage actions. Using the above two massage actions, a massage scheme suitable for customer needs is generated and provided to the operation terminal or automated equipment for execution. The operational characteristics of the massage scheme generation and execution unit 330 are as follows:
1. Personalized Process Design: Configured to dynamically generate a customized massage process by performing optimized combinations for different anatomical regions. For example, the unit may synthesize a new protocol by sequencing various massage actions derived from the subject's historical massage records to satisfy diverse therapeutic requirements.
2. Hardware Adaptation: To ensure the maximum fidelity in the reproduction of massage actions and techniques within the massage process, the unit selects one or more optimal massage hardware components based on the specific requirements of the generated massage scheme. Different massage actions are matched to the specific characteristics of different hardware devices. An illustrative embodiment of this hardware adaptation is provided in Table 5 below:

TABLE 5

| Hardware | Applicable | |
|---|---|---|
| Device | Scenarios | Technical Description |
| Robotic Arm | Back Pressing | Configured for pushing or pressing actions on the |
| | Actions | back/posterior region. The robotic arm provides precise |
| | | force control and structural stability, particularly suited |
| | | for actions requiring unidirectional force application and |
| | | high repeatability. |
| | Localized | Operations within specific small-scale areas (e.g., |
| | Massage | kneading actions on shoulders or arms). The robotic arm |
| | | performs high-precision tasks with specialized |
| | | interchangeable massage end-effectors. |
| Bionic Robot | Full-body | Configured for upper-body stretching actions. Utilizing a |
| | Lifting Actions | humanoid architecture and multi-degree-of-freedom |
| | | (multi-DOF) joint design, the bionic robot provides |
| | | stable support for the subject's body while performing |
| | | holistic lifting-a function not achievable by standard |
| | | robotic arms. |
| | Complex Action | Designed to emulate human-like actions such as |
| | Combinations | stepping, elbow strikes, or gentle head rotations. With |
| | | high-dexterity kinematic design, the bionic robot |
| | | executes multi-step continuous action sequences, |
| | | ensuring a smooth and natural transition between |
| | | movements. |
| Scraping | Localized | Provides targeted massage through adjustable force |
| (Gua Sha) | Relaxation of | modulation and intelligent control to achieve deep-tissue |
| Massage | Muscle | relaxation and enhanced comfort. |
| Device | Hypertonicity | |

By selecting the most suitable hardware device based on action characteristics, the massage scheme generation and execution unit 330 is capable of accurately reproducing massage techniques and processes, thereby satisfying personalized requirements while ensuring operational safety and efficiency.

Embodiments of multi-modal hardware devices: The aforementioned hardware adaptation requires multi-modal hardware devices, using embodiments as follows:
1. Robotic Arm: Featuring a seven-axis or higher degree-of-freedom (DOF) design to implement various massage actions (e.g., pushing, kneading, stretching, etc.). The robotic arm may further include specialized massage end-effectors (e.g., a heated massage head) to facilitate the reproduction of specific massage actions.
2. Bionic Robot 331: Equipped with a multi-degree-of-freedom joint structure to emulate humanoid massage actions, suitable for executing delicate and high-dexterity techniques. The bionic robot may include a built-in pressure sensor to achieve dynamic force adjustment and real-time safety protection. Referring to FIG. 6, in an embodiment, the bionic robot 331 comprises a head 332, a thorax control cabin 333, a right arm 334, a left arm 335, two six-axis wrists 336, a waist 337, two legs 338, and a power device 339. The thorax control cabin 333 houses associated control devices and electronic components. The head 332 is fixedly or rotatably coupled to an upper end of the thorax control cabin 333 and contains sensing devices (including an RGB-D camera). One end of the right arm 334 is rotatably coupled to one side (e.g., the right side) of the thorax control cabin 333. The right arm 334 serves as a pressing arm to execute massage actions (e.g., hip flexion or hamstring muscle massage) and may comprise multi-axis joints for flexible movement. One end of the left arm 335 is rotatably coupled to the other side (e.g., the left side) of the thorax control cabin 333. The left arm 335 serves as a supporting arm to assist in massage actions and may also comprise multi-axis joints capable of performing support and positioning functions. The two six-axis wrists 336 are respectively coupled to the distal ends (i.e., the end of the arm) of the right arm 334 and the left arm 335 to provide high-precision six-axis rotational control. A quick-release interface 340 is disposed at the end of each six-axis wrist 336 for rapid replacement or securing of specialized massage end-effectors (e.g., a heated massage head). The waist 337 is rotatably coupled to a lower end of the thorax control cabin 333 to provide waist rotation function, enabling the robot's upper body to rotate relative to its lower body. The two legs 338 are respectively coupled to both sides of the lower end of the waist 337 to support the robot in a humanoid standing posture and may comprise joints for limited mobility or stabilization. The power device 339 may be integrally installed within the waist 337 or the thorax control cabin 333 (as shown in the embodiment illustrated by FIG. 6) to supply power to all components, including an emergency stop function for safety. The bionic robot 331 is configured in a humanoid standing posture and is capable of executing massage actions including, but not limited to, hip flexion and hamstring muscle stimulation, thereby implementing the designated massage protocols. Referring to FIG. 7, in another embodiment, the bionic robot 331 further includes a wheeled mobile base 341 and an electronic braking device 342. The wheeled mobile base 341 is coupled to the lower ends of the two legs 338 (or directly replaces a portion of the leg structure) to mount wheels for ground mobility. The electronic braking device 342 is coupled to the wheeled mobile base 341 to control braking actions, ensuring stability and safety during movement. Thus, the bionic robot 331 utilizes a humanoid structure to precisely reproduce massage actions.
3. Safety Protection Mechanism: A safety design configured to prevent injury to the subject caused by the hardware device's massage application. Features of the mechanism are as follows:

Restricted Zone Identification: Combining depth camera data with artificial intelligence (AI) processing to identify restricted massage body parts on the subject's body surface (e.g., the head or injured areas) to automatically avoid high-risk regions.

Force Limitation System: Dynamically adjusting the force range based on pressure sensing data to ensure safety.

The real-time adjustment module 400 is based on systemic detection technology. Through precise data collection and analysis performed by a systemic detection unit, combined with artificial intelligence, the module dynamically adjusts the massage process and techniques. This ensures real-time adaptation to subject requirements and feedback during the massage process, providing a personalized and optimized massage experience. The real-time adjustment module 400 may be implemented through a systemic architecture, with operational embodiments as follows:

Module system architecture and operational embodiments: The real-time adjustment module 400 may be implemented as a hardware-software integrated system architecture comprising a systemic detection unit 410 and an AI massage therapist system and real-time adjustment unit 420. The systemic detection unit 410 is configured for real-time monitoring of the overall state of the subject's body. The AI massage therapist system and real-time adjustment unit 420 generates an optimized massage scheme based on data obtained from the systemic detection unit 410.

The systemic detection unit 410 performs real-time detection of the overall state of the subject's body, covering physiological parameters, postural changes, and pressure distribution. This provides precise data for the artificial intelligence to adjust the massage scheme. The systemic detection unit 410 comprises the following devices and systems:
1. Multi-Modal Sensing Device: Configured for real-time systemic detection during the massage process, as illustrated by Table 6 below:

TABLE 6

| Sensing Device | Functional Description |
|---|---|
| Pressure Sensor | Configured to monitor the pressure distribution on the |
| | subject's body surface and provide real-time force information |
| | for each massage session. |
| Action Capture Camera | Configured to capture changes in the subject's posture and |
| | actions by depth sensing technology, thereby providing 3D |
| | movement data. |
| Acoustic Sensing Device | Configured to capture the subject's vocal feedback (e.g., |
| | moans, snoring sounds, or physiological acoustic signals) and |
| | perform semantic analysis integrated with AI. |
| Physiological Parameter | Configured to record data such as heart rate and blood oxygen |
| Monitoring Device | levels to determine whether the massage intensity aligns with |
| | physiological requirements. |

2. Real-time Data Transmission and Analysis System: Directs the transmission of detected data to the AI system for processing, ensuring the rapid generation of dynamic adjustment schemes.
3. AI Massage Therapist System and Real-time Adjustment Unit 420: Based on the data input from the systemic detection unit 410, this unit integrates dynamic data analysis and device control functions. Utilizing artificial intelligence, it achieves real-time optimization and execution of the massage scheme, ensuring dynamic adaptation to the subject's real-time requirements during the massage process to provide an optimized, personalized massage experience. The unit operates based on data-driven triggers including scheme generation, real-time adjustment, and safety protection, comprising the following technical means:
(1) AI Dynamic Adjustment System: Configured to utilize artificial intelligence for real-time data analysis and optimization. By acquiring real-time data (e.g., pressure distribution, postural changes, vocal feedback, and physiological parameters) via the systemic detection unit, the system rapidly analyzes the subject's current requirements. The system dynamically generates or optimizes massage process parameters (e.g., force, step sequence, and restricted zones) and directly drives the hardware to ensure the scheme responds to the subject's current requirements. An embodiment of the adjustment system is as follows:

Subject Requirements: Neck and shoulder pain.

Historical Data: High satisfaction recorded for an “upward” force exerted on the neck, and satisfaction decreases when a force exerted on the shoulders is excessive.

Adjustments: Applying an “upward” force during neck pressing, with the force intensity maintained at 2.8-3.0 kg; during shoulder pressing, the force intensity is reduced to 2.5-2.7 kg.
(2) Fundamental Theory Integration System: Based on professional massage theories (e.g., myofascial therapy, orthopedic techniques), the system correlates the subject's real-time requirements with historical data (e.g., massage records and satisfaction feedback) to generate a personalized scheme with theoretical support. The system dynamically adjusts massage technique and region selection to ensure the generated scheme possesses high adaptability and a scientific basis.
(3) Semantic Analysis and Feedback System: Configured to utilize speech recognition technology to analyze subject feedback (e.g., locations of pain or comfort levels) and matches this with detected data to achieve real-time adjustment. Based on the analysis results, the system updates force control, action sequences, and force application zones to ensure the operation meets the subject's expectations and enhance massage experience.
(4) Device Control and Safety Dynamic Adjustment System: Based on the optimized scheme, this system drives the hardware for real-time adjustment while ensuring subject safety. The system comprises the operational units detailed in Table 7 below.

TABLE 7

| Unit Name | Functional Description |
|---|---|
| Device Control Unit | Configured to drive the robotic arm or bionic robot via |
| | commands to execute the optimized actions and processes. |
| Safety Protection | Configured to automatically reduce force intensity or modify |
| Mechanism Unit | techniques upon detecting pressure anomalies or subject |
| | discomfort reactions. The unit has a restricted zone |
| | identification function to avoid massaging the head or injured |
| | areas, ensuring operational safety. |

(5) Decision Model Auto-Evolution System: Based on the historical data and real-time feedback provided by the systemic detection unit 410, this system optimizes an AI-based dynamic decision model to achieve continuous learning and evolution. Historical data includes the subject's massage records (e.g., pressure distribution, force direction, massage body parts, and duration), previous feedback (e.g., satisfaction, pain regions), and physiological parameter changes (e.g., heart rate and blood oxygen levels). By integrating this data, the system improves the decision logic for more precise force control, region selection, and process adjustments, ensuring the generated scheme aligns highly with subject requirements.

Accordingly, the real-time adjustment module 400 implements a multi-factor satisfaction feedback loop. The systemic detection unit 410 captures facial expression data and acoustic signals. The AI massage therapist system and real-time adjustment unit 420 analyzes these signals to derive a satisfaction score S. If the satisfaction score S falls below a predetermined threshold, the AI engine triggers a RAG retrieval to find an alternative massage primitive sequence that reduces pressure or changes the trajectory path in real-time.

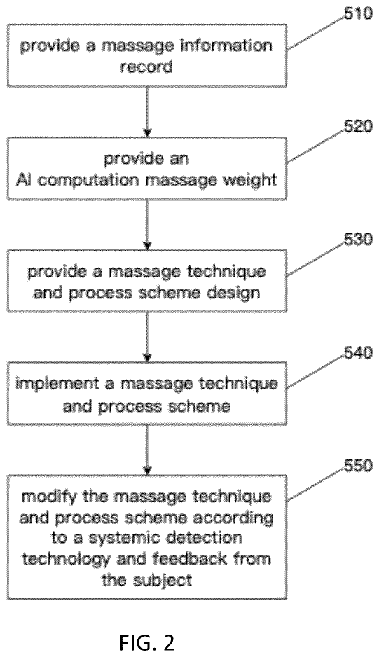

Referring to FIG. 2, it is another objective of the disclosure to provide a method for intelligent massage control. The following description utilizes a single subject as an illustrative embodiment: starting from an initial massage information recording, massage weight computation is performed on the recorded data via artificial intelligence (AI) to generate an optimized massage technique and process scheme, which is subsequently implemented through an operation terminal or automated equipment. Upon completion of the massage, the massage scheme is dynamically adjusted and optimized based on the subject's real-time feedback and systemic detection technology, ensuring that each massage session increasingly aligns with the subject's requirements and targeted experience. The steps of the method for intelligent massage control according to the disclosure are described below.

Step 510: Provide a massage information record. Real-time recording is performed on data including the pressure distribution, force direction, and massage regions of the subject during a massage session via the multi-modal sensing devices within the massage information recording module 200. This data is synthesized to form a complete massage information file, which serves as the foundational data for subsequent analytical processing.

Step 520: Provide an AI computation massage weight. The data collected by the massage information recording module 200 is input into the AI massage algorithm unit 320 of the massage technique and workflow construction module 300. The unit dynamically computes optimized massage end-effectors, techniques, and process parameters according to variables, such as the subject's age, health status, and satisfaction evaluation.

Step 530: Provide a massage technique and process scheme design. A complete personalized massage technique and process scheme is generated by the massage scheme generation and execution unit 330 of the massage technique and workflow construction module 300 according to the results from the AI massage algorithm unit 320. The massage scheme generation and execution unit 330 integrates hardware adaptation functions to select the most suitable execution device (e.g., a robotic arm or the bionic robot 331), thereby ensuring the feasibility and precision of the scheme.

Step 540: Implement a massage technique and process scheme. The massage scheme generation and execution unit 330 of the massage technique and workflow construction module 300 provides a generated massage process scheme to an operation terminal or automated equipment (e.g., a robotic arm or the bionic robot 331) for execution, thereby ensuring accurate operations during implementation and providing an optimized massage experience to the subject.

Step 550: Modify the massage technique and process scheme according to a systemic detection technology and feedback from the subject. The systemic detection unit 410 of the real-time adjustment module 400 performs real-time monitoring of physiological parameters, postural changes, and feedback data of the subject during the massage session. In integration with the AI massage therapist system and real-time adjustment unit 420, the massage technique and process scheme is dynamically optimized and updated to ensure that subsequent massage operations increasingly align with the requirements of the subject.

The intelligent massage control method may be implemented using the disclosed system and includes recording, analyzing, generating, applying, and dynamically modifying massage control parameters in a closed-loop feedback manner.

The disclosure may further comprise other features and applications as follows:

### A. Massage Management Applications

The AI massage therapist system and real-time adjustment unit 420 of the real-time adjustment module 400 may be extended to provide periodic massage management services for specific populations (e.g., the elderly or patients). By interfacing the units and systems within the real-time adjustment module 400, the following service delivery methods are provided:
(1) Regular Massage and Effect Tracking: The systemic detection unit 410 is configured to generate detailed records of the efficacy of each massage session, thereby providing data support for long-term longitudinal tracking.
(2) Integration of External Assistance: Modifying the massage scheme by combining the “AI dynamic adjustment system” with movement therapy.
(3) Scheduled Robotic Massage: Integrating the “device control and safety dynamic adjustment system” to automatically trigger automated equipment to perform massages, thereby achieving regular service.

### B. Devices not Limited to Specific Massage Technique Reproduction

The hardware adaptation of the massage scheme generation and execution unit 330 of the massage technique and workflow construction module 300 is not limited to specific devices. It is adaptable to multi-modal execution tools, including robotic arms, the bionic robot 331, and potential future innovative devices. This ensures that when devices capable of better reproducing massage techniques emerge, the devices used for updating the massage scheme can be upgraded accordingly.

### C. Massage Environment Reproduction

The data collection unit 210 of the massage information recording module 200 may record environmental characteristics of a massage setting, including ambient temperature, humidity, music, and equipment. The massage scheme generation and execution unit 330 of the massage technique and workflow construction module 300 incorporates these into a massage scheme capable of completely reproducing the original massage setting.

### D. Implementation Methods in the Absence of Specific Subject Massage Information

In an embodiment of the disclosure, the AI massage algorithm unit 320 of the massage technique and workflow construction module 300 may dynamically generate a massage scheme even in the absence of specific massage information for a subject, based on the following data:
(1) Historical Data: Including previous massage records of the subject (e.g., pressure distribution, force direction, massage regions, and duration), satisfaction evaluations, and associated health data (e.g., age and health status); and
(2) Detection Data: Universal model data obtained via the systemic detection unit, including force parameters, action modes, and environmental conditions analyzed through multi-modal sensing devices.

By synthesizing the aforementioned data through dynamic analysis and optimization, a universally adaptive massage technique and process scheme is generated; thus, a massage scheme suitable for the subject can be generated even in the absence of individual client-specific information.

### E. Calculation of Muscle Tightness Levels

The disclosure further includes a muscle tightness prediction model trained using at least one critical parameter record and artificial intelligence (AI). The muscle tightness prediction model is connected to the AI massage algorithm unit 320 and the AI massage therapist system and real-time adjustment unit 420 to predict muscle tightness. The at least one critical parameter record input into the muscle tightness prediction model includes time-series signals (e.g., motor current, joint angle, and velocity) to output corresponding muscle tightness levels. The muscle tightness prediction model is configured based on Recurrent Neural Networks (RNN) and Long Short-Term Memory (LSTM) networks, and is trained via supervised learning using a small amount of calibrated standard training data to address the dynamic time-varying characteristics of the at least one input critical parameter record that includes time-series signals (e.g., motor current, joint angle, and velocity).

### F. Calculation of Friction Force

The disclosure further includes a friction force prediction model trained using at least one critical parameter record and artificial intelligence (AI). The friction force prediction model is connected to the AI massage algorithm unit 320 and the AI massage therapist system and real-time adjustment unit 420 to predict friction force states. The at least one critical parameter record input into the friction force prediction model includes environmental factors (e.g., presence of lubricant, skin dryness/humidity, clothing material) to output corresponding friction force states and values. The friction force prediction model is based on a Large Language Model (LLM) architecture, from which a small-scale time-series model is generated via knowledge distillation or online inference based on the input numerical critical parameter records.

### G. Construction of Massage Technique and Process Schemes Based on Traditional Chinese Medicine (TCM) or Physical Therapy Data

When the client data provided by the massage information recording module 200 includes TCM or physical therapy data, the data analysis unit 310 uses the AI massage algorithm unit 320 via a system architecture based on Retrieval-Augmented Generation (RAG). This architecture is trained by integrating expert rules, knowledge graphs, and historical co-occurrence datasets to infer potential causal regions of the subject's symptoms. In one embodiment, the AI massage algorithm unit 320 infers potential causes of low back pain; if it is inferred that a cervical spine issue is causing descending pain, the generated massage scheme prioritizes treating the neck and follows a relaxation process downward along the associated muscle groups.

### H. Construction of Massage Technique and Process Schemes Based on Subject's Skin Marks and Color Distribution

The data analysis unit 310 may manually or automatically mark skin marks and color distribution of the subject on images-either through an OTRS (Operation, Time, Resource, and Sequence analysis tool) or AI recognition. Utilizing the AI massage algorithm unit 320 within a system architecture based on Vision-Color Segmentation algorithms and Retrieval-Augmented Generation (RAG) technology, the current causal regions of the subject's symptoms are inferred. In one embodiment, the AI massage algorithm unit 320 uses the Vision-Color Segmentation algorithm to identify ecchymosis regions and characteristics (e.g., age of the bruise) and classifies the color distribution (including proportions and intensity of red and purple). Subsequently, Retrieval-Augmented Generation (RAG) technology infers the causal region based on a model trained by integrating expert rules, knowledge graphs, and historical co-occurrence datasets, and generates the massage scheme using primitive grammar.

### I. Determining Sleep State Based on the Subject's Snoring Sounds or Physiological Signals

The systemic detection unit 410 uses the acoustic sensing device of the multi-modal sensing array to receive the subject's snoring sounds or physiological signals. Then, the AI massage therapist system and real-time adjustment unit 420, having been trained on snoring sound and physiological signal models using Convolutional Neural Networks (CNN) and Recurrent Neural networks (RNN), analyzes acoustic classifications to determine if the subject has fallen asleep. Upon such determination, the massage actions or scheme are switched to “gentle” or “continuous” types.

### J. Satisfaction Analysis Based on the Subject's Facial Expressions

The systemic detection unit 410 uses the action capture camera of the multi-modal sensing array to analyze the subject's facial expressions. Then, the AI massage therapist system and real-time adjustment unit 420 analyzes the subject's current satisfaction with the massage scheme and massage actions, directly driving the equipment to adjust the massage in real time.

### K. Determination of Massage Termination Timing

The systemic detection unit 410 uses devices, such as the pressure sensor of the multi-modal sensing device, to monitor the muscle tightness in the massage region. When the muscle tightness decreases to a predetermined level, indicating completion of muscle relaxation, the execution of the massage actions or scheme can be terminated. Alternatively, the AI massage therapist system and real-time adjustment unit 420 estimates the total massage duration based on critical parameter records, referencing the average time the subject took to undergo each massage action in previous massage schemes, thereby determining the massage termination timing.

### L. Post-Massage Recommendations

Regarding the aforementioned determination of massage termination timing, the AI massage therapist system and real-time adjustment unit 420 of the disclosure further includes a post-massage recommendation AI model. The post-massage recommendation AI model is based on a Large Language Model (LLM) architecture and is configured to provide analytical suggestions based on the execution results of the current massage scheme and the physical status values of the subject. In one embodiment, the post-massage recommendation AI model correlates the subject's tightest muscle groups, primary pain points, and post-massage real-time feedback with known symptoms to infer potential causes of symptoms and provide healthcare recommendations to the subject.

In conclusion, compared to conventional technologies and prior art, the present disclosure possesses the following advantages:
1. Precision Reproduction of Massage Techniques and 24-Hour Availability: Conventional massage chairs are limited to performing massages on specific areas, and their techniques and effects cannot be flexibly adjusted. The data collection unit 210 of the massage information recording module 200 acquires force magnitudes from the bionic robot 331 and robotic arms, enabling the massage scheme generation and execution unit 330 of the massage technique and workflow construction module 300 to reproduce the techniques of a human practitioner. Furthermore, the bionic robot 331 and robotic arms do not require rest but can operate 24 hours a day, achieving an around-the-clock, on-demand massage effect.
2. Integrated Upgrade of Pressure and Tension Sensing: Existing devices, such as those disclosed in China Patent No. 113143749B, possess only pressure sensors and cannot identify or process tension, making “push-pull” actions difficult to implement. The data collection unit 210 of the massage information recording module 200 incorporates a tension sensor at the palm center of the subject and integrates vision recognition technology to accurately distinguish between pressure and tension. By utilizing an OTRS (Operation, Time, Resource, and Sequence analysis tool) for manual image labeling after video recording, or through automated AI image labeling, higher precision in push-pull massage actions is achieved.
3. Expanded Adaptability for Massage Postures and Actions: Certain existing equipment, such as that disclosed in U.S. Patent Publication No. 20240341874A1, only supports minor massages in a prone position and cannot implement diverse push-pull actions, resulting in a singular technique. The AI massage algorithm unit 320 of the massage technique and workflow construction module 300, utilizing the bionic robot 331 and robotic arms as a foundation, supports various massage postures and intensity requirements. Techniques ranging from pushing and pulling to pressing can be precisely implemented, enhancing massage efficacy and flexibility.
4. AI Massage Technology Featuring Dynamic Learning and Weight Optimization: Existing equipment, such as that disclosed in China Patent No. 110347449B, cannot adjust massage processes according to individual requirements and changing conditions, lacking specificity and intelligence. The AI massage algorithm unit 320 of the massage technique and workflow construction module 300 integrates Long Short-Term Memory (LSTM) technology to assign greater weight to recent massage data while filtering out unnecessary data. By flexibly adjusting combinations of massage techniques and weights, an optimized massage effect is achieved.
5. Systemic Detection for Precise Recognition of Nerve and Relaxation States: Conventional equipment, such as that disclosed in Taiwan Patent No. 1856922B, performs massages only on muscles, ignoring differences between nerve tension and full-body relaxation. The systemic detection unit 410 of the real-time adjustment module 400 transmits detected data directly to the AI system for processing to identify the subject's nerve tension levels (e.g., sciatic nerve, cervical/shoulder nerves). By simultaneously analyzing the relaxation state, the system dynamically adjusts the appropriate massage techniques and integrates methods such as shiatsu to further enhance efficacy, realizing a truly personalized and systemic relaxation scheme.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, even though the elements of a claim are set forth below in a certain combination, it must be expressly understood that the embodiment includes other combinations of fewer, more, or different elements disclosed herein even when not initially claimed in such combinations.

Thus, specific embodiments and applications of an intelligent massage system and an intelligent massage control method have been disclosed. It should be apparent, however, to those skilled in the art that many more modifications besides those already described are possible without departing from the disclosed concepts herein. Therefore, the disclosed embodiments are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be substituted, and what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings but to include by special definition in this specification structure, material, or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in the same way to obtain the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. An intelligent massage system comprising:
a multi-modal sensing array configured to capture real-time dynamic data of a subject during a massage session, the real-time dynamic data including at least a pressure distribution, a force vector, and a three-dimensional (3D) trajectory of a massage movement;
a plan construction module comprising a processor and an artificial intelligence (AI) engine, the AI engine configured to:
derive a satisfaction evaluation metric based on the real-time dynamic data;
dynamically analyze a health profile of the subject and the satisfaction evaluation metric; and
generate a personalized massage protocol comprising a sequence of massage primitives and force parameters;
an automated actuator configured to physically implement a massage protocol on the subject; and
a real-time adjustment module operably coupled to the automated actuator and configured to:
monitor a physiological state of the subject based on sensor signals from the multi-modal sensing array during execution of the personalized massage protocol; and
dynamically modify at least one parameter of the personalized massage protocol based on a feedback control loop integrating the monitored physiological state and a pre-trained professional massage logic to generate a modified personalized massage protocol;
wherein the automated actuator is configured to physically implement the modified personalized massage protocol on the subject.

2. The intelligent massage system of claim 1, wherein the multi-modal sensing array comprises a pressure sensing glove configured to detect pressure magnitude and force direction at a palm region and a plurality of fingertip regions, and a depth camera configured to capture a three-dimensional trajectory of massage movements in a spatial coordinate system.

3. The intelligent massage system of claim 1, wherein the multi-modal sensing array comprises a pulling-force sensing system configured to detect tension applied during the massage session and including at least one of a strain gauge disposed on a pull rod or a tension sensor coupled to a strap configured to transmit massage force.

4. The intelligent massage system of claim 1, wherein the automated actuator comprises at least one strap configured to transmit a massage force to the subject, the at least one strap comprising a front strap configured to apply a massage force to a front portion of the subject's body and a back strap configured to stabilize the applied massage force.

5. The intelligent massage system of claim 1, wherein the automated actuator comprises a motor operably coupled to a force transmission element selected from the group consisting of a strap and a pull rod, and a current sensor configured to monitor electrical current supplied to the motor to infer applied massage force, and the automated actuator further comprises at least one of a multi-degree-of-freedom joint structure and an interchangeable massage end-effector.

6. The intelligent massage system of claim 1, wherein the feedback control loop limits a maximum massage force based on the monitored physiological state of the subject.

7. The intelligent massage system of claim 1, wherein the real-time adjustment module is configured to interrupt or reduce massage force when the monitored physiological state exceeds a predefined safety threshold.

8. The intelligent massage system of claim 1, wherein the personalized massage protocol further defines a temporal sequence of massage primitives each associated with a corresponding force-time profile.

9. The intelligent massage system of claim 1, wherein the feedback control loop is configured to adjust at least one of massage force magnitude, direction, timing, or application location based on the three-dimensional trajectory captured by the multi-modal sensing array.

10. The intelligent massage system of claim 1, wherein the plan construction module is further configured to generate the personalized massage protocol using historical massage data associated with prior massage sessions of the subject.

11. The intelligent massage system of claim 1, wherein sensor signals generated by the strain gauge and pull rod are provided as input features to the artificial intelligence engine, and wherein output of the artificial intelligence engine is converted into control signals for the automated actuator to regulate applied massage force.

12. A method for intelligent massage control, comprising:
capturing, by a multi-modal sensing array, real-time dynamic data of a subject during a massage session, the dynamic data comprising at least a pressure distribution, a force vector, and a three-dimensional (3D) trajectory of a massage movement;
dynamically analyzing, by a processor executing an artificial-intelligence-based algorithm, the dynamic data and subject information including a health profile and a satisfaction evaluation metric;
generating, based on the analysis, a personalized massage protocol defining control instructions for an automated actuator for applying a massage force to the subject, the personalized massage protocol comprising a sequence of massage primitives and force parameters;
applying, by the automated actuator, a massage force to the subject in accordance with the personalized massage protocol;
monitoring, during execution of the personalized massage protocol, a physiological state of the subject based on sensor signals from the multi-modal sensing array; and
dynamically modifying at least one parameter of the personalized massage protocol based on a feedback control loop integrating the monitored physiological state and a pre-trained professional massage logic,
wherein the automated actuator physically implements the dynamically modified personalized massage protocol on the subject in real time.

13. The method of claim 12, wherein capturing the real-time dynamic data comprises detecting pressure magnitude and force direction at a palm region and a plurality of fingertip regions using a pressure sensing glove, and capturing a three-dimensional (3D) trajectory of the massage movement using a depth camera.

14. The method of claim 12, wherein capturing the real-time dynamic data further comprises detecting a pulling force applied during the massage session using at least one of a strain gauge disposed on a pull rod or a tension sensor coupled to a strap configured to transmit massage force.

15. The method of claim 12, wherein applying the massage force comprises transmitting the massage force to the subject via at least one strap, including a front strap positioned to apply massage force to a front portion of the subject's body and a back strap positioned to stabilize the applied massage force.

16. The method of claim 12, wherein applying the massage force comprises driving a motor operably coupled to a force transmission element selected from the group consisting of a strap and a pull rod, and wherein monitoring the physiological state comprises monitoring electrical current supplied to the motor to infer applied massage force.

17. The method of claim 12, wherein dynamically modifying the at least one parameter of the personalized massage protocol comprises limiting, interrupting, or reducing massage force when the monitored physiological state exceeds a predefined safety threshold.

18. The method of claim 12, wherein dynamically analyzing comprises processing force measurements from a strain gauge and a pull rod as input to an artificial intelligence model, and wherein dynamically modifying comprises outputting actuator control signals based on model output.

19. An intelligent massage system, comprising:
a massage information recording module configured to record dynamic massage information of a subject during execution of a massage operation, the massage information recording module comprising:
a data collection unit configured to collect sensor signals from a plurality of sensors;
a sensor interface unit electrically connected to the plurality of sensors; and
a data storage unit configured to store massage data,
wherein the massage data comprise at least pressure, applied force direction, and massage location associated with the subject during the massage operation;
a massage technique and workflow construction module, comprising a processor executing an artificial-intelligence-based algorithm configured to dynamically analyze the massage data and subject information including age, health condition, and satisfaction evaluation, and to generate massage control parameters defining a personalized massage technique and workflow;
a massage optimization and real-time adjustment module configured to, based on whole-body sensing and real-time feedback from the plurality of sensors, dynamically modify the massage control parameters during the massage operation using an artificial-intelligence technique; and
a massage force application assembly configured to apply a controllable massage force to the subject in accordance with the massage control parameters, the massage force application assembly comprising at least one force transmission element and at least one drive element;
wherein the plurality of sensors comprise at least a pressure sensing glove configured to detect pressure variations and force directions applied during the massage operation, and a depth camera configured to record motion details and three-dimensional movement trajectories to provide motion reproduction parameters, and wherein the massage force application assembly is controlled in real time based on the dynamically modified massage control parameters to adjust at least one of massage force magnitude, direction, timing, or application location during execution of the massage operation.

20. The intelligent massage system of claim 19, wherein the massage technique and workflow construction module decomposes the personalized massage technique and workflow into a plurality of massage primitives each defined by a force parameter and a motion trajectory, and wherein the massage optimization and real-time adjustment module limits, interrupts, or reduces massage force when sensor-derived feedback exceeds a predefined safety threshold.
